(19) United States
(12) Patent Application Publication
(10) Pub. No.: US 2009/0211699 A1
(43) Pub. Date: Aug. 27, 2009

(54) NOVEL METHOD TO AFFIX AN OPTICAL ELEMENT

(75) Inventors: Armando Montalvo, Woodland Hills, CA (US); Albert Garden, Woodland Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SABEUS, INC., Calabasas, CA (US)

(21) Appl. No.: 11/816,087

(22) PCT Filed: Feb. 24, 2006
(86) PCT No.: PCT/US06/06959

§ 371 Date: Feb. 23, 2009

Related U.S. Application Data
(60) Provisional application No. 60/656,563, filed on Feb. 25, 2005.

(51) Int. Cl. B29C 65/02; B29C 65/00

(52) U.S. Cl. 156/272.8; 156/60

(57) ABSTRACT

A method for affixing an adjustable optical element in place to allow for tuning an optical device during assembly of the device, but which provides for fixation of the element in place after adjustment.

### CROSS-REFERENCES TO RELATED APPLICATIONS

This application claims the benefit of priority to U.S. Provisional Application No. 60/656,563, filed Feb. 25, 2005, the subject matter of which is being incorporated herein in its entirety.

### FIELD OF THE INVENTION

This invention relates generally to a method of directing a light source, and more particularly, to setting an optical element which is illuminated by a light source.

### BACKGROUND OF THE INVENTION

Wavelength is often adjusted by means of a wavelength selective filter element through which a beam of radiation is transmitted whereby the adjusted wavelength depends on the angle of inclination of the filter element relative to the optical axis. A typical filter element of this kind is a Fabry-Perot etalon which comprises a resonator cavity that is formed by two reflective elements, for example, highly reflecting elements, such as, for example, highly reflecting mirrors, and an active medium or gain medium arranged inside the cavity. The wavelength of the transmitted radiation is adjusted by carefully tilting the etalon relative to the optical axis where the optical spectrum of the laser is limited by the spectral region over which the gain medium yields optical gain. The wavelength (Lamda) for which the etalon has maximum transmission is a function of the angle (alpha) of the surface normal to the etalon relative to the optical axis. Tilting is typically performed manually or by a motor driven tilting apparatus, where the etalon is mounted on a tiltable or rotatable table. Unfortunately, the aforementioned cases do not provide the needed accuracy since by the time the table is secured, the etalon has moved and since the motor accuracy is limited by complexity and cost. Moreover, adjustment of a filter such as an etalon is necessary to correct for imperfections and other limitations resulting from fabrication of the filter. This need for adjustment applies not applies to etalons but to optical elements of all sorts that need to be mounted, aligned and set.

### SUMMARY OF THE INVENTION

The present invention solves the above problem by providing a quick and accurate method for mounting, aligning and setting (i.e., rigidly affixing) elements. In particular, with the present invention, adjusting the wavelength of an optical etalon is fast, easy and highly accurate. The present invention allows for small independent and incremental adjustments, constant heat flow and dissipation and active alignment and tuning, without requiring a complex and costly drive. In a preferred embodiment, the present invention uses a pivot, made of an Ultra Low Expansion (ULE) (a trademark of Corning, Inc.) glass,, Zerodour (a trademark of Schott AG), or fused silica material, attached to a surface of an optical element where the pivot is substantially flat on one surface, where it attaches to the optical element, and substantially spherical on another surface, where is attaches to a optical bench (or optical train—which may be adapted to receive pivots and substantially flat or spherical). In such case, when the optical element and pivot are in their appropriate position, a bonding agent such as an epoxy material is preferably applied in the area between the pivot and optical element and then cured by it irradiating with a (typically using an ultraviolet (UV)) light source to set (i.e., rigidly affix) the pivot and optical element together (herein also called “optical assembly”) in an optimal position. Laser soldering or laser welding may also be used to set (i.e., rigidly affix) the pivot and optical element in an optimal position together.

A bonding agent is preferably applied in the area between the pivot and optical bench before the pivot and optical element (optical assembly) are aligned and mounted on the optical bench. When an optimal position is reached by aligning the optical assembly on the optical bench, the optical assembly is preferably set (i.e., rigidly affixed) to the optical bench by curing the bonding agent (by irradiating with a light source, typically UV light) in-between the optical bench and assembly. Laser soldering or laser welding may also be used to set (i.e., rigidly affix) the assembly in an optimal position on the optical bench.

The optical element in the preferred embodiment is a Fabry-Perot etalon, although, it is understood that the invention is not limited to Fabry-Perot etalons. Furthermore, it is understood that the invention may also be used with other devices wherein such adjustment is needed which requires high resolution, accuracy and repeatability but which demands low cost and complexity. Other features of the present invention are described below in connection with a detailed description of a preferred embodiment.

In another aspect, the present invention includes a method to affix an optical element to a optical bench, comprising the steps of affixing a pivot to the optical element, wherein an optical assembly is generated; mounting the optical assembly to the optical bench; aligning the optical assembly with respect to a determined position; and affixing the optical assembly to the optical bench. In yet another aspect, the step of affixing the pivot to the optical element comprises the steps of applying a bonding agent between the pivot and optical element, and curing the bonding agent to rigidly affix the pivot to the optical element.

In still another aspect, the step of affixing the pivot to the optical element comprises the step of welding the pivot to the optical element to rigidly affix the pivot to the optical element, and in a further aspect, the step of affixing the pivot to the optical element comprises the step of soldering the pivot to the optical element to rigidly affix the pivot to the optical element.

In yet another aspect, the step of aligning is done manually. In another alternative aspect, the step of affixing the optical assembly to the optical bench comprises the steps of applying a bonding agent between the assembly and optical bench, and curing the bonding agent to rigidly affix the assembly to the optical bench. In still another alternative aspect, step of affixing the optical assembly to the optical bench comprises the step of using laser soldering to rigidly affix the assembly to the optical bench. In yet another alternative aspect, the step of affixing the optical assembly to the optical bench comprises the step of using laser welding to rigidly affix the assembly to the optical bench.

In another aspect of the present invention, the pivot is made of Ultra Low Expansion (ULE) glass, Zerodour, or fused silica, and in another aspect, the optical element is an etalon. In still another aspect, the optical element is formed of Ultra Low Expansion (ULE) glass, Zerodour, or fused silica.

In yet another aspect, the optical element is an optical component, and in a further aspect, the pivot is substantially flat on one side and substantially spherical on another side. In a still further aspect, the optical bench is adapted to receive the pivot.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a perspective exploded view of various elements of an optical device incorporating an embodiment of the present invention.

FIG. 2 is a perspective view of an optical element having an adjustable mount in accordance with one embodiment of the present invention affixed thereto.

FIG. 3 is a side view of the embodiment of the mount of FIG. 2.

FIG. 4 is perspective view of the embodiment of the mount of FIG. 2.

### DETAILED DESCRIPTION OF THE PREFERRED EMBODIMENTS

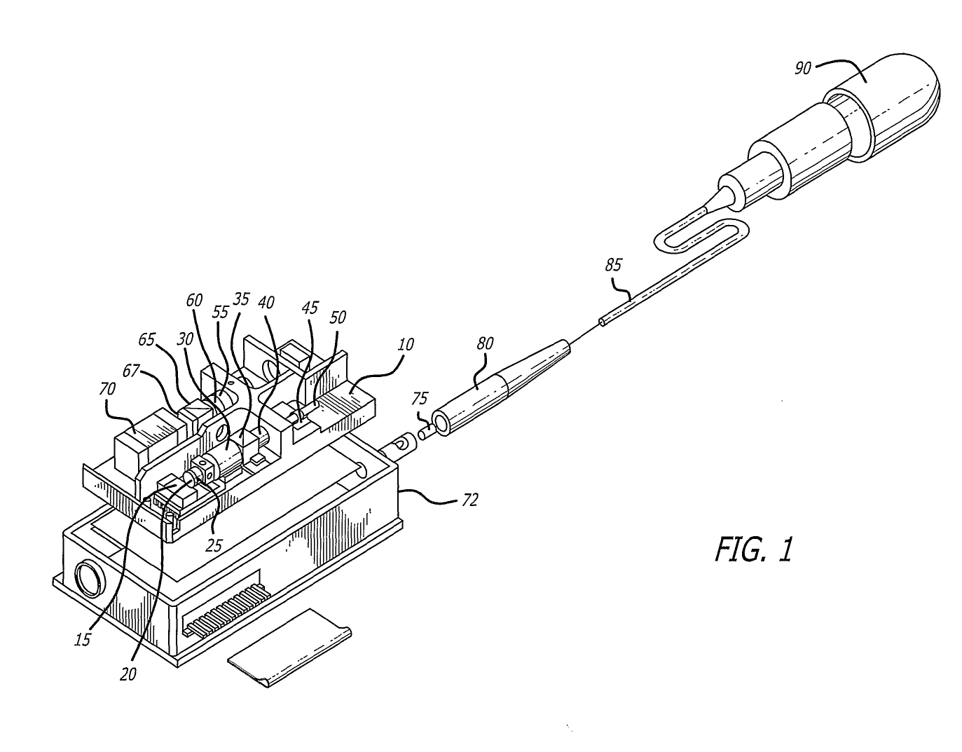

Referring now to the drawings in detail, in which like reference numerals indicate like or corresponding elements among the several figures, there is shown FIG. 1 an exemplary optical assembly illustrating one use of the present invention. The illustrative device includes an optical bench assembly 10 on which is mounted an optical train. The optical train in this example includes a laser 15, an aspheric lens 20, a collimating tube 25, a faraday isolator 30, a beam splitter 35 a capillary fiber ferrule 50 and a fiber ferrule weld clip 45. Beam splitter 35 directs a portion of the light emitted from laser 15 to beam splitter 65, where a portion of the beam is directed through a plano convex lens 60 and a tube 55. The other portion of the light beam split by beam splitter 65 is reflected a quarter wave plate 67 into an etalon 70.

As will be apparent to those skilled in the art, accurate placement and alignment of each element in the optical train is important to the efficient and accurate performance of the device. The wavelength of the device is adjusted using etalon 60, which is a wavelength selective filter. In a filter of this type, the adjusted wavelength depends on the angle of inclination of the filter element relative to the optical axis.

A Fabry-Perot etalon is typically used for such an adjustment. An etalon includes a resonator cavity that is formed by two reflective element, such as, for example, highly reflecting mirrors, and an active medium or gain medium arranged inside the cavity. The wavelength of radiation transmitted through the optical device is adjusted by carefully tilting the etalon relative to the optical axis where the optical spectrum of the laser is limited by the spectral region over which the gain medium yields optical gain. The wavelength (Lamda) for which the etalon has maximum transmission is a function of the angle (alpha) of the surface normal to the etalon relative to the optical axis. Tilting is typically performed manually or by a motor driven tilting apparatus, where the etalon is mounted on a tiltable or rotatable table. Unfortunately, the moving the etalon or the optical train often results in changing the tilt of the filter such that the device needs further tuning.

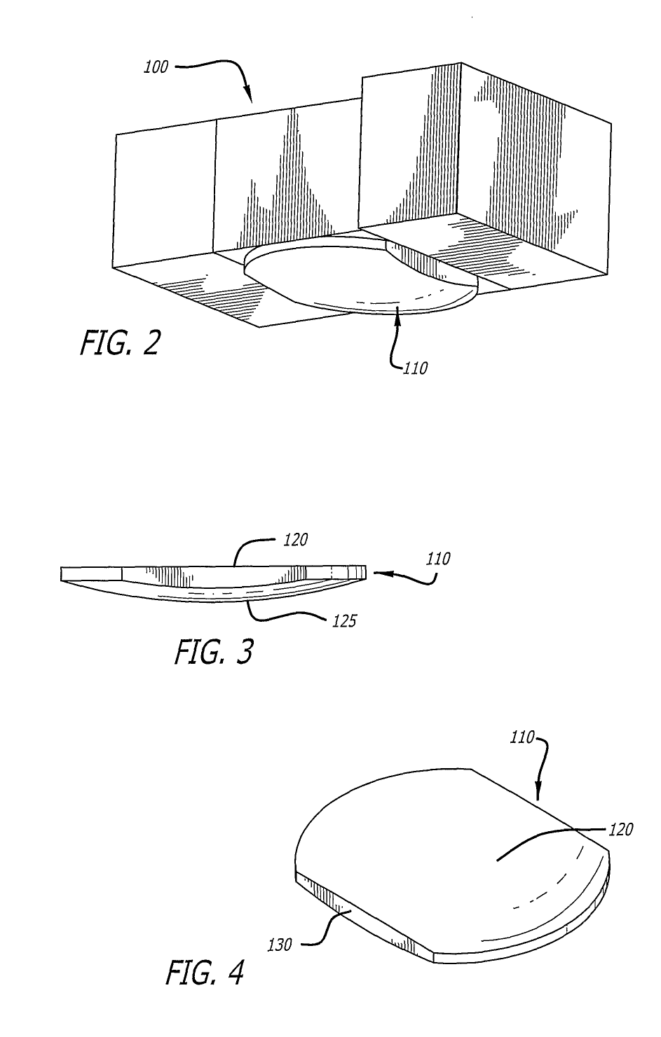

Referring now to FIG. 2, which illustrates one embodiment of the present invention, there is shown an etalon 100 to which is attached a mount 110. FIGS. 3 and 4 shows additional details of the mount 110. Mount 110 has a plano side configured to abut a bottom side of etalon 100. An opposite side 125 of the mount 110 is formed in a convex shape. Convex side 125 is configured to be received by a concave receiver (not shown) disposed on the surface of optical bench 10. (FIG. 1). It will be apparent to those skilled in the art that the convex side 125 of mount 110 and the concave receiver cooperate to allow etalon 100 to be tilted so as to facilitate tuning of the wavelength of radiation transmitted by the device.

In more general terms, the adjustable optical illustrated herein typically consists of an optical element, such as, for example, an air gap or solid etalon, and a pivot. The optical element and pivot are typically made of structurally compatible materials such as Ultra Low Expansion (ULE) glass, Zerodour, or fused silica. The optical element may be any dimensioned component and the pivot, as illustrated by mount 110, is substantially flat on one side and substantially spherical on another, wherein each side is separated from the other by a substantially small distance as compared to the length of the substantially flat or spherical sides. Material compatibility is desired to minimize any possible stresses on the optical material due to temperature variations. Compatible materials of similar properties also help to dissipate and transfer heat.

When the optical element and pivot are mounted together, a low outgasing irradiation cured bonding agent (e.g., Norland 81 epoxy) is preferably used to rigidly affix the optical element to the pivot. Alternatively, laser welding or laser soldering may be used instead of a bonding agent. In the event laser welding or soldering are used, the optical element and pivot should be metalized in the bonding point area. In such case, the metal deposition is preferably gold (Au); however, an equivalent may be used. Since the optical assembly structure is optically contacted, care must be exercised when handling the optical assembly so as to not disturb the alignment and structure since it will affect the performance of the optical assembly.

The following describes a method in accordance with the present invention for aligning the optical assembly to ensure that the proper wavelength is transmitted. Coarse alignment of the optical assembly is typically performed outside of the optical module housing 72 (FIG. 1) before attempting final alignment on the optical bench. In the case where the optical element is an etalon, a laser diode, such as the laser 15 shown in FIG. 1, is modulated by modulating the current powering the laser diode by using a function generator. The modulation may be, for example, a 20 Hz ramp function and the peak-to-peak amplitude should be adjusted so as to allow at least 60 mA peak to peak modulation. A DC control may also be used to find the transmission peaks of the optical element.

Pre-aligmnent of the center of the optical element to the center of an impinging light beam is accomplished by placing a large-area InGaAs photodiode, which may have, for example, a diameter of approximately 3 mm, behind the optical element. A right angle mirror may also be used to steer the beam to a better location for the photo-diode. If a quarter waveplate and polarized beam splitter (PBS) have been installed in the optical train, a pinhole may be used between the PBS and the receiver lens to pre-align the optical element. Once pre-alignment has been successfully completed, the pinhole may be removed.

The transmission output pattern of the optical train is monitored on an oscilloscope and the optical assembly angles in the X-Y directions are adjusted to maximize the peak height of the transmission peaks and optimize alignment. The X-Y offset may also have to be adjusted to maximize transmission peaks. Once the desired alignment is reached, the optical assembly is ready to be set (i.e., rigidly affixed) into place. In other words, once the desired alignment has been achieved, the optical assembly is moved into the housing 72, typically by using a translation stage and grabber.

The optical assembly is placed on top of the optical bench by using an up-and-down micrometer and is lowered to the optical bench until the optical assembly rests on the optical bench and comes to full stop. The desired alignment should be easy to achieve since the optical element angles are approximately correct, having been determined during the pre-alignment procedure. Once the desired transmission peaks have been observed, a mirror is inserted at about 45 degrees between a receiver lens hole on the optical bench 10 and a receiver aperture hole on the housing 72. To locate the beam, another photo-diode is inserted and an x-y-z translation stage is used to maximize the power. The detector must have enough speed to enable reflection dip detection.

The optical element efficiency may be determined by observing the intensity drop from an L-I curve on an oscilloscope and calculating the efficiency. A minimum of about 40 percent coupling efficiency is typically required when using an etalon. Once a satisfactory efficiency has been obtained, the optical assembly with translation stations is lifted from the optical bench, some bonding agent is applied between the pivot, in other words, the mount 110, and the concave receiver of the optical bench. The optical assembly is then lowered onto the optical bench so that the mount 110 makes contact with the concave receiver of the optical bench. It will be understood that while the surface of receiver is preferably substantially spherical and concave, to receive the convex side of mount 110, the surface of the receiver may also be substantially flat.

A final check of all signals on the oscilloscope is performed to fine tune the position of the etalon 70 within micrometers so as to produce the desired signal wavelength and power. Once the desired result is achieved, the optical assembly is cured (i.e., rigidly affix) to the optical bench by irradiating the UV sensitive adhesive previously placed between the mount 110 and receiver, with UV light preferably for about eight minutes or as recommended by the manufacturer of the adhesive or bonding agent. Alternatively, laser welding or laser soldering may be used instead of a bonding agent. In the event laser welding or soldering are used, the mount 110 and optical bench should be metalized in the bonding point area. In such case, the metal deposition is preferably gold (Au); however, an equivalent may be used.

Although this invention has been described in certain specific embodiments, those skilled in the art will have no difficulty devising variations which in no way depart from the scope and spirit of the present invention. For example, although the present invention is described with respect to specific components associated with setting an optical element, a person skilled in the art should recognize that any of the tasks may be combined into a particular element or delegated to separate elements. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

We claim:

1. A method to affix an optical element to a optical bench, comprising the steps of:
affixing a pivot to the optical element, wherein an optical assembly is generated;
mounting the optical assembly to the optical bench;
aligning the optical assembly with respect to a determined position; and
affixing the optical assembly to the optical bench.

2. The method according to claim 1, wherein the step of affixing the pivot to the optical element comprising the steps of:
applying a bonding agent between the pivot and optical element, and
curing the bonding agent to rigidly affix the pivot to the optical element.

3. The method according to claim 1, wherein the step of affixing the pivot to the optical element comprises the step of welding the pivot to the optical element to rigidly affix the pivot to the optical element.

4. The method according to claim 1, wherein the step of affixing the pivot to the optical element comprises the step of soldering the pivot to the optical element to rigidly affix the pivot to the optical element.

5. The method according to claim 1, wherein the step of aligning is done manually.

6. The method according to claim 1, wherein the step of affixing the optical assembly to the optical bench comprises the steps of:
applying a bonding agent between the assembly and optical bench, and
curing the bonding agent to rigidly affix the assembly to the optical bench.

7. The method according to claim 1, wherein the step of affixing the optical assembly to the optical bench comprises the step of using laser soldering to rigidly affix the assembly to the optical bench.

8. The method according to claim 1, wherein the step of affixing the optical assembly to the optical bench comprises the step of using laser welding to rigidly affix the assembly to the optical bench.

9. The method according to claim 1, wherein the pivot is made of Ultra Low Expansion (ULE) glass, Zerodour, or fused silica.

10. The method according to claim 1, wherein the optical element is an etalon.

11. The method according to claim 1, wherein the optical element is Ultra Low Expansion (ULE) glass, Zerodour, or fused silica.

12. The method according to claim 1, wherein the optical element is an optical component.

13. The method according to claim 1, wherein the pivot is substantially flat on one side and substantially spherical on another side.

14. The method according to claim 1, wherein the optical bench is adapted to receive the pivot.
